(19) United States
(12) Patent Application Publication
(10) Pub. No.: US 2010/0256293 A1
(43) Pub. Date: Oct. 7, 2010

(54) No added formaldehyde, sag resistant ceiling tile coating

(76) Inventor: Lida Lu, Lancaster, PA (US)

Correspondence Address: ARMSTRONG WORLD INDUSTRIES, INC.;LEGAL DEPARTMENT, P. O. BOX 3001, LANCASTER, PA, 17604-3001, US

(21) Appl. No.: 12/798,289

(22) Filed: Apr. 1, 2010

Related U.S. Application Data
(60) Provisional application No. 61/166,006, filed on Apr. 2, 2009.

(51) Int. Cl. C08L 37/00

(52) U.S. Cl. 524/549; 525/384

(57) ABSTRACT

A formaldehyde-free coating for a fibrous substrate is provided. The coating includes a thermoset binder system having a polymer binder and a crosslinker, wherein the thermoset binder system is waterborne and has an alkali pH from about 7 to about 10. The coating has a high modulus and the ability to hygroscopically expand.

### CROSS REFERENCE TO RELATED APPLICATION

This application claims the benefit under 35 U.S.C. §119(e) of U.S. provisional application Ser. No. 61/166,006, filed Apr. 2, 2009.

### BACKGROUND OF THE INVENTION

The present invention is related to coatings, and, in particular, to a formaldehyde-free coating that is applied onto the back of a fibrous panel to resist sag.

It is widely known that fibrous acoustic ceiling boards sag as they go through high and low humidity cycles after installation. Sag can be reduced by means of coatings or scrims applied either on the back or face of the tiles. A fibrous acoustic ceiling board without coatings on both surfaces suspended only by four edges will sag with time and particularly under high humidity conditions due to the sensitivity of board binders and fibers to the moisture.

Typically, fibrous acoustic ceiling boards are covered with coating layers on opposing surfaces: namely, a finishing coating layer on the face to give esthetic appearance and a special coating layer on the back to furnish board with sag resistant and also acoustic properties. The sag resistant coating layer applied on the back of the panel will create an expansion force to resist the compressive force during sagging at high humidity conditions. The greater the expansion of the coating layer, the better sag resistance the whole board will gain.

In order for a coating to have such unique properties mentioned above several special characteristics are very necessary. First, it should have high modulus particularly at high relative humidity. Second, it should also have high humidity expansion coefficient. In other words, it should be hydrophilic in nature, capable of absorbing/desorbing moisture in the air, and hence its volume expands or shrinks as the humidity changes. Sag resistance at high humidity can be achieved only when the back coating layer expansion exceeds the expansion of the rest of the boards, i.e., the face coating layer and the substrate board. Such back coating should have a binder material which is hydrophilic and be capable of absorbing moisture with rising humidity and desorbing moisture with decreasing humidity.

Typical coating binder materials are organic polymers. There are many organic polymers that are hydrophilic in nature such as starches, cellulose, polyvinyl alcohol, polyethylene oxide, polyacrylic acid, polyacrylamide, polyimide, etc. However most of these polymers either do not have enough moisture absorbing capability or do not have high modulus or lose modulus, i.e., softens, after absorbing moisture. They are not suitable to be used as back coating binders directly. In order for a hydrophilic polymer to maintain its high modulus after absorbing high level of moisture polymer modifications are necessary. One practical method is to modify polymers by means of crosslinkers. Once the polymer is properly crosslinked polymer matrix expansion will be limited. Hence, the polymer softening, or loss of modulus at high humidity conditions will be very limited.

One example of anti-sag coating binder is melamine formaldehyde polymer. It is a thermoset polymer due to its highly crosslinked structure. This polymer is very hydrophilic with a lot of hydroxyl and amino groups that are capable to absorb moistures in the high humidity atmosphere. An early application of melamine formaldehyde resin as an anti-sag coating binder for fibrous board can be seen in a U.S. Pat. No. 3,243,340 by Cadotte etc.

This melamine formaldehyde resin and its modified versions (e.g. modified with urea formaldehyde) have been the preferred resin system for several decades. One reason is that the melamine formaldehyde based coating can be made waterborne. Thus, the application of the coating becomes really easy. Another reason is that as the formaldehyde based resins (including phenol formaldehyde, melamine formaldehyde, and urea formaldehyde) have become commodity polymers, their cost has become significantly low. However, it has been found out the building materials containing formaldehyde based resins emit formaldehyde slowly with time. It is not until recently that formaldehyde emission into the buildings becomes increasingly concerned due to its effect to human health. Therefore, coatings which do not emit formaldehyde are very desirable.

There have been attempts to replace formaldehyde based coating with formaldehyde free coatings. For example, some hydrophilic polymers modified with crosslinkers have been utilized to replace the formaldehyde based coating binders on ceiling panels. U.S. Patent application publication No. 2007/0055012 describes using crosslinkable polymer with hydrophilic moiety chemically attached to the crosslinked system. When the polymer is used as back coating binder and fully cured the back coating expands more than the hydrophobic face coating at high humidity environment. Thus, the ceiling panels achieve anti-sag properties through low and high humidity cycles. However, the crosslinkable polymer coating systems is at very low pH and is not compatible with other coating system that have a neutral or high pH.

U.S. patent application publication No. 2007/0277948 describes the development of a formaldehyde free acoustical tile. The document describes using formaldehyde free latex binders and biocide in the coatings. However, the coating binders used on the tile are hydrophobic and do not exhibit any hygroscopic expansion properties. Coatings based on these types of binders do not have enough sag resistant properties and therefore stronger boards are required.

U.S. patent application publication No. 2007/0292619 describes a formaldehyde-free binder that utilizes a hydrolyzed copolymer of styrene maleic anhydride and a polyol to make nonwoven fiberglass binders. U.S. patent application publication No. 2008/0119609 describes a modified binder system for nonwoven fiberglass applications. Its chemistry comprises the reaction product of a polyanhydride, a polyol crosslinker, and a low molecular weight anhydride. Unfortunately, the binders in these applications are not used as an anti-sag coating binder on ceiling panels. In addition, there is no mention of the hygroscopic expansion properties of the binders. Their formulation is optimized for maximum water or moisture resistance. As a matter of fact the hygroscopic expansion properties of such binders are unwanted in the nonwoven fiberglass applications. This is because hydroscopic expansion property is detrimental to dimensional stability of fiberglass mat.

Therefore, what is needed is a coating which can be used to replace existing formaldehyde based coatings and which has a high modulus, the ability to hygroscopically expand and is compatible with other coatings in the neutral or high pH range.

### SUMMARY OF THE INVENTION

The present invention is a formaldehyde-free coating based on a polymer binder and crosslinker that is waterborne and has mild alkaline pH. The binder system comprises polyanhydrides hydrolyzed in aqueous solution and polyols capable to crosslink the polymer to form three dimensional networks. Coatings based on this binder composition are compatible with other coating systems with neutral or mild alkaline pH. When the coating is applied to the back of fibrous boards either by spray or roll coating cured coating has high modulus and hygroscopic expansion property. Panels to which the coating is applied exhibit anti-sag properties which are very similar to the melamine formaldehyde based back coating.

Furthermore, the binder system can incorporate renewable materials when proper polyols are used. Those renewable materials have relatively low cost compared with petroleum based raw materials. Therefore, the use of renewable polyols in the coating binder system not only improves the greenness of the coating chemistry, but also reduces the coating cost. Typical renewable polyols include glycerol, glucose, sucrose and sorbitol.

The formulations of the coating are an improvements over existing coatings in that they are optimized against coating modulus and hygroscopic expansion properties such that the use of binder in the coatings is fully maximized. Because of mild alkaline pH and its compatibility to the non-acidic coatings, it makes the manufacturing easy without a need of separating the new coating from the other coatings. All the current coating equipment can be used without any modification or additions. Thus, initial capital cost can be avoided.

### DETAILED DESCRIPTION OF THE EMBODIMENT(S)

The present invention particularly relates to a waterborne binder system that has mild alkaline pH, i.e. a pH of from about 6 to about 10, compatible with other coatings, various fillers, and processing equipment. The preferred binder system includes a polyol and a copolymer of maleic anhydride (or maleic acid) and a vinyl aromatic compound hydrolyzed in aqueous ammonia, a secondary alkanolamine (preferably diethanolamine), a tertiary alkanolamine (preferably triethanolamine), or a mixture thereof. More specifically, the new binder system contains a hydrolyzed styrene maleic anhydride (SMA) copolymer solubilized in aqueous ammonia, diethanolamine, triethanolamine, or a mixture thereof. Depending on the type of polyols used, the cured coating based on SMA and polyol binder composition exhibit a modulus of from about 4 to about 12 GPa and lose less than 15% of their strength at 90% relative humidity.

By way of example, an SMA copolymer such as SMA-1000H, obtained from Sartomer Inc. is a polymer hydrolyzed in an aqueous ammonia solution with molecular weight of 5,000 and styrene to maleic anhydride ratio in the range from about 1:1 to about 6:1(hydrophobic:hydrophilic). Hydrolyzed SMA copolymer contains ammonium salt of maleic acid. It is these hydrophilic groups that can be utilized for crosslinking with polyols to form ester groups that give the coating of the invention its high modulus nature.

Polyols are polyhydric alcohols containing two or more hydroxyl groups. The best known polyol is triethanolamine (TEA) due to its additional amine nitrogen which also helps to increase moisture absorption. Other polyols will work as well such as diethanolamine, ethyl diethanolamine, methyl diethanolamine, glycerol, ethylene glycol, diethylene glycol, tryethylene glycol, hydroxyl terminated polyethyleneoxide, pentaerythritol, trimethylol propane, sorbitol, sucrose, glucose (i.e., dextrose), resorcinol, catechol, pyrogallol, glycollated ureas, polyvinyl alcohol, 1,4-cyclohexane diol, etc. Polyols from renewable resources are becoming very attractive due to their renewability, low toxicity, and low cost. The preferred green polyols includes glycerol, glucose (dextrose), sucrose, and sorbitol, etc.

A high degree of crosslinking gives the coating a high modulus but low hydrophilicity since ester group is not hydrophilic. The remaining unreacted hydrophilic moieties become moisture absorbing sites. Whereas, a low degree of crosslinking gives the coating a high hydrophilicity but low modulus. Therefore, the ratio between SMA and the polyol, e.g. TEA, can be manipulated to optimize the hygroscopic expansion properties and modulus. Filler can be added to synergistically reduce the coating cost and increase the coating modulus at the same time.

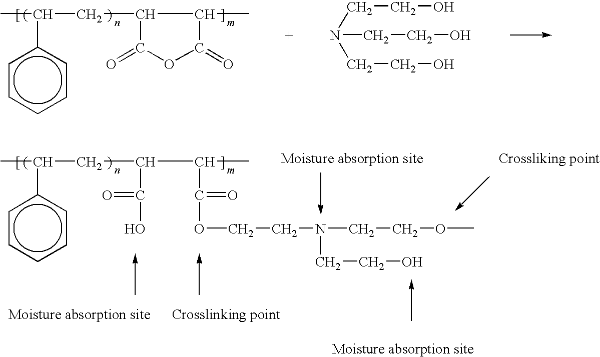

Modifications or equivalent parts can be substituted without changing the basic invention. The best type of copolymer that works for the application of sag resistant coating is 1:1 styrene to maleic anhydride ratio due to its maximum hydrophilicity after the polymer being hydrolyzed. A low molecular weight of SMA polymer from about 500 to about 100,000 is the best to be used for the desired solids content which is from 20% to 80%, more preferably from 40% to 60%. Styrene can be substituted with other vinyl monomers such as ethylene, propylene, vinyl chloride, acrylates, methacrylonitrile, isoprene, isobutene, vinyl acetate, vinyl propionate, vinyl stearate, vinyl butyrate and combinations thereof.

### Example 1

The waterborne coating is made in the following procedure: 339.0 g SMA1000H was added into a mixer containing 284.6 g water. While mixing 39.4 g triethanolamine (TEA), 2.0 g 1-methylimidazole as catalyst, 1.0 g defoamer, and 334.0 g Kaolin clay as filler were added into the container. The finished coating has solids content of 50%, Brookfield viscosity of 1,060 cps, and pH of 8.9. This coating has filler (Kaolin clay) to binder (i.e., SMA-1000H and TEA) ratio at 2:1 and carboxyl to hydroxyl molar ratio at 1.6:1. Dynamic mechanical analysis test indicated that the coating film had a modulus of 9 GPa.

The coating was applied to the back side of ceiling tile with application weight of 20 grams per square foot. In order to balance the ceiling tile stress caused by drying the coating a prime coating comprising starch and kaolin clay filler at solids about 50% was also applied to the front side of the ceiling tile with application weight of 20 grams per square foot. The coated tile was then dried and cured at 410 F for 10 minutes in an oven. The coated tile was then placed in the sag testing room to go through specified low and high humidity test cycles. After 4 cycles of humidity cycle test, this tile sagged to about −291 mils.

### Examples 2-4

These coatings were made in the same way as example 1 except that the ratios of filler to binder were changed. The carboxyl to hydroxyl molar ratio for examples 2-4 was still kept the same at 1.6:1. The coating application and curing procedure was also as same as in Example 1.

### Comparative Example

Melamine formaldehyde based coating was made in the following procedure: 100.0 g BTLM 860 was dissolved into 494.0 g water in a container. While mixing 400.0 g Kaolin clay, 4.0 g triethylamine as inhibitor, 1.0 g ammonium sulfate as catalyst, 1.0 g defoamer were added into the container. The finished coating had about 50% solids, 400 cps Brookfield viscosity, and 8.5 pH. The coating application and curing procedure was the same as in Example 1.

TABLE 1
Sag results of SMA based back coatings after 4 cycles

| | | Filler to | |
|---|---|---|---|
| Examples | Coating type | binder ratio | Sag in mils |
| Example 1 | SMA and TEA | 2.0:1 | −291 |
| Example 2 | SMA and TEA | 2.7:1 | −180 |
| Example 3 | SMA and TEA | 3.8:1 | −224 |
| Example 4 | SMA and TEA | 6.0:1 | −269 |
| Comparative | Melamine | 4.0:1 | −176 |
| example | formaldehyde | | |

A maximum sag value is observed at filler to binder ratio of 2.7:1 (Example 2) indicating the existing of an optimum of filler to binder ratio. The coating in Example 1 with lower filler to binder ratio exhibited worse sag than that of the coating in Example 2, thus, indicating the possibility of over-expansion of the coating at high humidity.

### Example 5

The coating using SMA and glycerol was made as follows: 328.0 g SMA-1000H was added into a mixer containing 291.0 g water. While mixing 38.0 g glycerol, 2.0 g 1-methylimidazole, 1.0 g defoamer, and 340.0 g Kaolin clay were added into the mixer. The resulting coating has filler to binder ratio of 2.1:1, carboxyl to hydroxyl molar ratio of 1:1, 50% solids, and 630 cps viscosity. Following the same coating application method as example 1 the tile was cured at 410 F for 10 minutes. This coated tile has a sag value of −215 mils after 4 humidity cycles.

### Example 6

The coating using SMA and dextrose was made as follows: 202.0 g SMA-1000H was added into a mixer containing 369.0 g water. While mixing 69.0 g dextrose (glucose), 2.0 g 1-methylimidazole, 1.0 g defoamer, and 357.0 g Kaolin clay were added into the mixer. The resulting coating has filler to binder ratio of 2.5:1, carboxyl to hydroxyl molar ratio of 0.4:1, 50% solids, and 2700 cps viscosity. Following the same coating application method as example 1 the tile was cured at 380 F for 10 minutes. This coated tile has a sag value of −201 mils after 4 humidity cycles.

The foregoing illustrates some of the possibilities for practicing the invention. Many other embodiments are possible within the scope and spirit of the invention. For example, although the coating is described herein as being incorporated in a ceiling tile structure, it will be appreciated by those skilled in the art, however, that the coating may have other applications, for example, in the building, furniture, or automotive industry. It is, therefore, intended that the foregoing description be regarded as illustrative rather than limiting, and that the scope of the invention is given by the appended claims together with their full range of equivalents.

I claim:

1. A formaldehyde-free coating for a fibrous substrate, the coating comprising:
a thermoset binder system having a polymer and a polyol as a crosslinker, wherein the thermoset binder system is waterborne and has an alkali pH from about 6 to about 10,
whereby the coating has a high modulus and the ability to hygroscopically expand.

2. The formaldehyde-free coating of claim 1, wherein the thermoset binder system includes styrene maleic anhydride copolymer.

3. The formaldehyde-free coating of claim 1, wherein the wherein the polyol is selected from the group consisting of triehanolamine, glycerol and glucose.

4. The formaldehyde-free coating of claim 1, wherein the modulus of a cured coating is about 4 to about 10 GPa.

5. The formaldehyde-free coating of claim 1, wherein a cured coating loses less than 15% of its strength at 90% relative humidity.

6. The formaldehyde-free coating of claim 2, wherein the styrene maleic anhydride copolymer includes a styrene to maleic anhydride monomer ratio in the range from about 1:1 to about 6:1.

7. The formaldehyde-free coating of claim 6, wherein the styrene to maleic anhydride monomer ratio is 1:1.

8. The formaldehyde-free coating of claim 2, wherein the solids content is from about 20% to about 80% by weight.

9. The formaldehyde-free coating of claim 2, wherein the solids content is from about 40% to about 60% by weight.

10. The formaldehyde-free coating of claim 8, wherein styrene maleic anhydride has a molecular weight from about 500 to about 100,000.

11. The formaldehyde-free coating of claim 2, wherein the coating comprises a filler.

12. The formaldehyde-free coating of claim 2, wherein the coating has a carboxyl to hydroxyl molar ratio of about 5:1 to about 0.1:1.
